(19) United States
(12) Patent Application Publication
(10) Pub. No.: US 2026/0084403 A1
(43) Pub. Date: Mar. 26, 2026

(54) LAMINATED GLASS AND VEHICLE

(71) Applicant: FUYAO GLASS INDUSTRY GROUP CO., LTD., Fuzhou (CN)

(72) Inventors: An CHEN, Fuqing (CN); Feng CAI, Fuqing (CN); Hongfei WANG, Fuqing (CN)

(21) Appl. No.: 19/338,866

(22) Filed: Sep. 24, 2025

(30) Foreign Application Priority Data
Sep. 26, 2024 (CN) 202411347140.6

(51) Int. Cl. B32B 17/10; B32B 7/12; B32B 27/08

(52) U.S. Cl. CPC B32B 17/10064; B32B 7/12; B32B 17/10651; B32B 27/08; B32B 2250/04; B32B 2307/416; B32B 2307/418; B32B 2307/7376; B32B 2605/003

(57) ABSTRACT

A laminated glass includes an outer glass sheet, an inner glass sheet, an adhesive layer, and a non-metal reflective film that are stacked with each other. The outer glass sheet has a first surface and a second surface. The inner glass sheet has a third surface and a fourth surface. The adhesive layer is located between the second surface and the third surface. The non-metal reflective film is located between the second surface and the adhesive layer, or is located between the adhesive layer and the third surface, or is located on the fourth surface, or is located inside the adhesive layer. A solar direct reflectance RE of the laminated glass measured from a first surface side satisfies RE≥12%. A vehicle includes the laminated glass as described above.

### CROSS-REFERENCE TO RELATED APPLICATION

This application claims priority to Chinese patent application No. 202411347140.6, filed on Sep. 26, 2024, the content of which is hereby incorporated by reference in its entirety.

### TECHNICAL FIELD

The present application relates to the technical field of vehicle glass, and particularly to a laminated glass and a vehicle.

### BACKGROUND

With the rise of new energy vehicles, automotive design not only pursues innovation and fashion but also emphasizes energy efficiency and environmental friendliness. A low drag coefficient is critical to achieving these goals, as it is a critical factor for significantly reducing air resistance during driving, thereby lowering energy consumption and extending the driving range of the electric vehicle. To satisfy the demand for low drag, many automakers have begun adopting large-sized panoramic front windshield, sunroof, and rear windshield. These designs not only enhance the vehicle's visual appeal but also provide a relatively broad view for passengers. However, as the glass coverage area of the vehicle increases, thermal insulation becomes a particularly prominent issue. A large area of glass easily absorbs solar radiation, leading to an increased interior temperature, which not only compromises passenger comfort but also raises the energy consumption of the air conditioning system, offsetting the energy efficiency benefits brought by the low-drag designs. Consequently, thermal insulation has become an important consideration in vehicle thermal management.

To address the issue of thermal insulation, most automakers adopt metal coatings with high reflectivity to block infrared and ultraviolet light in solar radiation, effectively reducing heat accumulation inside the vehicle. For example, a metal coating or an alloy coating is directly deposited on a certain glass surface of laminated glass to obtain a metal-coated glass. Alternatively, the metal coating is deposited on a PET film to obtain a metal-coated PET film, which is then applied to the laminated glass.

However, while the use of the metal coatings for reflection can provide thermal insulation, it has been observed in practical use that laminated glass with metal coatings may interfere with the electromagnetic environment around antennas, and may cause a certain degree of shielding of the electromagnetic wave signals emitted by the antennas, leading to signal attenuation, reduced antenna sensitivity and coverage, and ultimately impairing the quality of wireless communication inside the vehicle.

### SUMMARY

In view of this, a first aspect of the present application provides a laminated glass, the technical solutions of which are as follows:

A laminated glass provided by the present application includes an outer glass sheet, an inner glass sheet, an adhesive layer, and a non-metal reflective film that are stacked with each other, wherein the outer glass sheet has a first surface and a second surface, the inner glass sheet has a third surface and a fourth surface; the adhesive layer is located between the second surface and the third surface; the non-metal reflective film is located between the second surface and the adhesive layer, or is located between the adhesive layer and the third surface, or is located on the fourth surface, or is located inside the adhesive layer;

a solar direct reflectance RE of the laminated glass measured from a first surface side satisfies RE≥12%.

In some embodiments, the non-metal reflective film includes a high refractive index layer and a low refractive index layer that are alternately stacked with each other, wherein a refractive index of the high refractive index layer is denoted as n1, a refractive index of the low refractive index layer is denoted as n2, and n1 and n2 satisfy n1−n2≥0.05.

In some embodiments, the non-metal reflective film further includes a polymer film, and the high refractive index layer and the low refractive index layer are alternately stacked on at least one surface of the polymer film.

In some embodiments, the non-metal reflective film further includes a color-adjusting layer, the color-adjusting layer is in direct contact only with the high refractive index layer of the non-metal reflective film, or is in direct contact only with the low refractive index layer of the non-metal reflective film, or is located between adjacent high refractive index layer and low refractive index layer.

In some embodiments, a thickness of the color-adjusting layer is in a range from 0.1 μm to 15 μm, or from 1 μm to 10 μm.

In some embodiments, a thickness of the non-metal reflective film is in a range from 40 μm to 200 μm.

In some embodiments, the high refractive index layer and the low refractive index layer are a plurality of high refractive index layers and a plurality of low refractive index layers that are alternately stacked with each other. In some embodiments, a material of the high refractive index layers and a material of the low refractive index layers each are an inorganic compound, and a total layer number of the high refractive index layers and the low refractive index layers is in a range from 4 to 20.

In some embodiments, the laminated glass includes at least one of following features:
(1) the material of the high refractive index layers is an oxide, a nitride, or an oxynitride, and n1 satisfies n1≥2.0;
(2) the material of the low refractive index layers is an oxide or a fluoride, and n2 satisfies n2≤1.8;

$$n 1 - n 2 ⩾ 0.2 , n 1 - n 2 ⩾ 0.5 , n 1 - n 2 ⩾ 0.8 , or n 1 - n 2 ⩾ 1. ; \qquad ( 3 )$$

(4) the material of the high refractive index layers is an oxide, a nitride, or an oxynitride of at least one element selected from Zn, Ti, Si, Al, Sn, Se, Zr, Ni, In, Cr, W, Ca, Y, Nb, Cu, or Sm;
(5) the material of the low refractive index layers is an oxide or a fluoride of at least one element selected from Si, Al, or Mg.

In some embodiments, the high refractive index layer and the low refractive index layer are a plurality of high refractive index layers and a plurality of low refractive index layers that are alternately stacked with each other. In some embodiments, a material of the high refractive index layers and a material of the low refractive index layers each are an organic polymer, a total number of the high refractive index layers and the low refractive index layers is in a range from 50 to 5000, and the organic polymer is at least one selected from polyethylene, polypropylene, polylactic acid, poly(4-methyl-1-pentene), polyvinylidene difluoride, cyclic polyolefin, polymethyl methacrylate, polyvinyl chloride, polyvinyl alcohol, polyamide, polystyrene, polycarbonate, polyethylene terephthalate, polyethylene naphthalate, polyphenylene sulfide, and polyetherimide; n1−n2≤0.15, or n1−n2≤0.1.

In some embodiments, the laminated glass has a reflectance of at least 75% for near-infrared light in a wavelength range from 900 nm to 1100 nm incident from the first surface side.

In some embodiments, in a frequency range from 30 MHz to 3000 MHz, an absolute difference between a maximum signal attenuation and a minimum signal attenuation caused by the laminated glass is less than or equal to 10 dB.

In some embodiments, a visible light transmittance of the non-metal reflective film is greater than or equal to 85%, or the visible light transmittance of the non-metal reflective film is greater than 75% but less than or equal to 80%, or the visible light transmittance of the non-metal reflective film is less than or equal to 60%.

In some embodiments, a visible light transmittance of the laminated glass is greater than or equal to 70%, a total solar energy transmittance of the laminated glass is less than or equal to 60%, RE≥20%, and a visible light reflectance of the laminated glass measured from the first surface side is less than or equal to 15%.

In some embodiments, a visible light transmittance of the laminated glass is less than or equal to 10% and a total solar energy transmittance of the laminated glass is less than or equal to 30%.

In some embodiments, a visible light transmittance of the laminated glass is greater than or equal to 70%, a total solar energy transmittance of the laminated glass is less than or equal to 55%, and RE≥20%.

In some embodiments, a shrinkage rate of the non-metal reflective film in a machine direction MD is in a range from 2% to 4.5% and a shrinkage rate of the non-metal reflective film in a transverse direction TD is in a range from 1.1% to 4%.

In some embodiments, a minimum distance between a contour boundary of the non-metal reflective film and a contour boundary of the laminated glass is in a range from 5 mm to 20 mm.

In some embodiments, the color of light reflected from an outer surface of the laminated glass measured from the first surface side has following values in a Lab color space: value a is in a range from −2 to 0 and value b is in a range from −2 to 0.5, or value a is in a range from −1 to 0 and value b is in a range from −1 to 0.5; or value a is in a range from −0.5 to 0 and value b is in a range from −0.5 to 0.5.

A second aspect of the present application provides a vehicle, which includes the laminated glass as described above.

Compared with conventional solutions, the present application has the following beneficial effects:

In the present application, the non-metal reflective film is incorporated in the laminated glass, which can directly replace conventional metal coatings and reflect infrared light, addressing the thermal insulation issues in vehicle thermal management. Compared with the laminated glass incorporating metal coatings, the laminated glass incorporating the non-metal reflective film has a dielectric constant closer to that of the surrounding air, which avoids interference with the electromagnetic environment around antennas, shielding substantially no electromagnetic wave signals emitted by the antennas, thereby ensuring high signal transmittance and improving the quality of wireless communication inside the vehicle. Additionally, unlike the deposited metal coatings, which are prone to showing color deviation due to process adjustments, the non-metal reflective film is less sensitive to the process adjustments, preventing color deviation and contributing to the vehicle's overall appearance and aesthetic appeal. Moreover, the production and manufacturing costs of the non-metal reflective film are lower than those of depositing metal coatings, helping to reduce product costs.

### BRIEF DESCRIPTION OF THE DRAWINGS

In order to illustrate the technical solutions in the embodiments of the present application more clearly and to provide a comprehensive understanding of the present application and the beneficial effects thereof, the drawings used in the embodiments will be described briefly. Apparently, the following described drawings are merely for the embodiments of the present application, and other drawings can be derived based on these drawings by those of ordinary skill in the art without any creative effort.

FIG. 1 is a schematic structural view of a laminated glass according to a first embodiment of the present application.

FIG. 2 is a schematic structural view of a laminated glass according to a second embodiment of the present application.

FIG. 3 is a schematic structural view of a laminated glass according to a third embodiment of the present application.

FIG. 4 is a schematic structural view of a laminated glass according to a fourth embodiment of the present application.

FIG. 5 is a schematic structural view of a first embodiment of a non-metal reflective film according to the present application.

FIG. 6 is a schematic structural view of a second embodiment of a non-metal reflective film according to the present application.

FIG. 7 is a schematic top view showing a contour of a laminated glass according to the present application.

### DETAILED DESCRIPTION

The present application will now be described in detail with reference to the specific embodiments. The present application can be implemented in many different forms and is not limited to the embodiments described herein. Rather, these embodiments are provided to make the contents disclosed in the present application more thoroughly and comprehensive.

Unless otherwise defined, all technical and scientific terms used herein have the same meaning as commonly understood by those of ordinary skill in the art to which the present application pertains. The terms used in the specification of the present application herein are for the purpose of describing specific embodiments only and are not intended to limit the present application.

### Terms

Unless otherwise stated or there is a contradiction, terms or phrases used herein have the following meanings:

In the present application, the terms “a plurality of”, “multiple”, “many times”, “multiple elements” and the like refer to a number equal to or greater than 2, unless otherwise specified. For example, “one or more” means one, two, or more.

In the present application, the terms “first”, “second” “third”, and “fourth” are used solely for descriptive purposes. They should not be interpreted as indicating or implying relative importance or quantity, nor should they suggest the significance or number of the technical features referenced. Moreover, “first”, “second”, “third”, “fourth” and the like only serve the purpose of non-exhaustive enumeration, and it should be understood that they do not constitute a closed-ended limitation on the quantity.

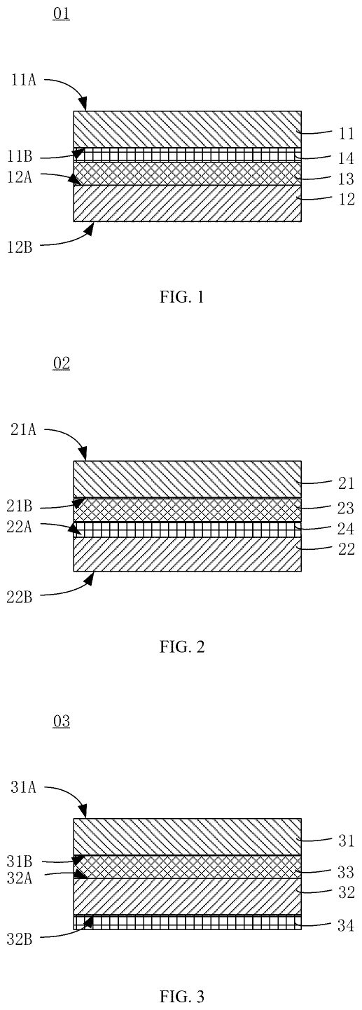

A first aspect of the present application provides a laminated glass. Referring to FIG. 1, in a first embodiment, the laminated glass 01 includes an outer glass sheet 11, an inner glass sheet 12, an adhesive layer 13, and a non-metal reflective film 14 that are stacked with each other. The outer glass sheet 11 has a first surface 11A and a second surface 11B. The inner glass sheet 12 has a third surface 12A and a fourth surface 12B. The adhesive layer 13 is located between the second surface 11B and the third surface 12A. The non-metal reflective film 14 is located between the second surface 11B and the adhesive layer 13.

Referring to FIG. 2, in a second embodiment, the laminated glass 02 includes an outer glass sheet 21, an inner glass sheet 22, an adhesive layer 23, and a non-metal reflective film 24 that are stacked with each other. The outer glass sheet 21 has a first surface 21A and a second surface 21B. The inner glass sheet 22 has a third surface 22A and a fourth surface 22B. The adhesive layer 23 is located between the second surface 21B and the third surface 22A. The non-metal reflective film 24 is located between the adhesive layer 23 and the third surface 22A.

Referring to FIG. 3, in a third embodiment, the laminated glass 03 includes an outer glass sheet 31, an inner glass sheet 32, an adhesive layer 33, and a non-metal reflective film 34 that are stacked with each other. The outer glass sheet 31 has a first surface 31A and a second surface 31B. The inner glass sheet 32 has a third surface 32A and a fourth surface 32B. The adhesive layer 33 is located between the second surface 31B and the third surface 32A. The non-metal reflective film 34 is located on the fourth surface 32B.

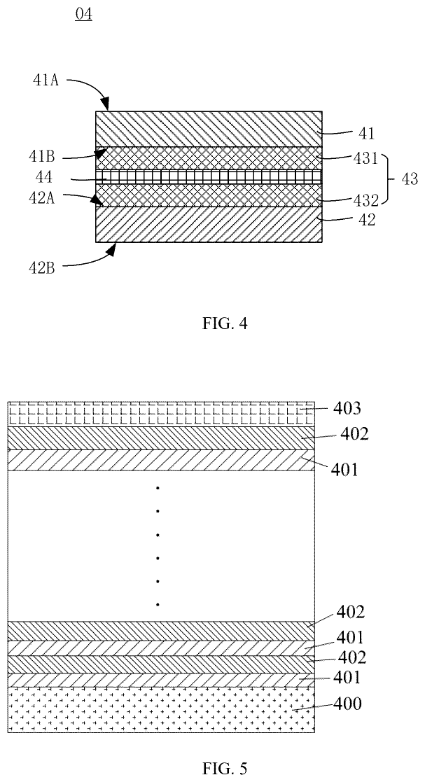

Referring to FIG. 4, in a fourth embodiment, the laminated glass 04 includes an outer glass sheet 41, an inner glass sheet 42, an adhesive layer 43, and a non-metal reflective film 44 that are stacked with each other. The outer glass sheet 41 has a first surface 41A and a second surface 41B. The inner glass sheet 42 has a third surface 42A and a fourth surface 42B. The adhesive layer 43 is located between the second surface 41B and the third surface 42A. The adhesive layer 43 includes a first adhesive layer 431 and second adhesive layer 432 that are stacked with each other. The non-metal reflective film 44 is located between the first adhesive layer 431 and the second adhesive layer 432. In other embodiments, the non-metal reflective film can alternatively be located inside the adhesive layer in other structures.

In the above embodiments, the first surface can be the outer surface of the laminated glass facing the exterior of the vehicle, and the fourth surface can be the inner surface of the laminated glass facing the interior of the vehicle. The solar direct reflectance RE of the laminated glass measured from the first surface side satisfies: RE≥12%. In the above embodiments, the laminated glass incorporates a non-metal reflective film, which can reflect infrared light, addressing thermal insulation issues in vehicle thermal management. Further optionally, the solar direct reflectance RE of the laminated glass measured from the first surface side satisfies: RE≥20%. Further optionally, the solar direct reflectance RE of the laminated glass measured from the first surface side satisfies: RE≥45%. The higher the solar direct reflectance RE, the better the thermal insulation performance of the laminated glass.

In some embodiments, the laminated glass has a reflectance of at least 75% for near-infrared light in a wavelength range from 900 nm to 1100 nm incident from the first surface side. Further, the laminated glass has a reflectance of at least 80% for near-infrared light in a wavelength range from 900 nm to 1100 nm incident from the first surface side. Furthermore, the laminated glass has a reflectance of at least 85% for near-infrared light in a wavelength range from 900 nm to 1100 nm incident from the first surface side. Moreover, the laminated glass has a reflectance of at least 90% for near-infrared light in a wavelength range from 900 nm to 1100 nm incident from the first surface side. Since human skin is particularly sensitive to heat in the wavelength range around 1000 nm, the laminated glass provided in the present application not only exhibits excellent thermal insulation performance but also further enhances the comfort of passengers inside the vehicle.

Conventional laminated glass with metal coatings has a dielectric constant different from that of the surrounding air, and metals possess specific electromagnetic properties that can affect the electromagnetic environment around antennas, generating a certain degree of shielding of the electromagnetic wave signals emitted by the antennas, leading to signal attenuation. This adversely affects antenna transmission or reception efficiency, reducing antenna sensitivity and coverage, and impairing the quality of wireless communication inside the vehicle. In contrast to conventional metal coatings, by incorporating a non-metal reflective film, the laminated glass can avoid interference with the electromagnetic environment around the antennas, shielding substantially no electromagnetic wave signals emitted by the antennas, thereby ensuring high transmittance for 5G signals, Wi-Fi signals, Bluetooth signals, GPS signals, ETC signals, universal garage-door openers' signals, etc., minimizing communication signal attenuation caused by the laminated glass. Optionally, in a frequency range from 30 MHz to 3000 MHz, an absolute difference between a maximum signal attenuation and a minimum signal attenuation caused by the laminated glass is less than or equal to 10 dB, ensuring consistent signal transmission across the entire frequency range from 30 MHz to 3000 MHz. Further optionally, in the frequency range from 30 MHz to 3000 MHz, the absolute difference between the maximum signal attenuation and the minimum signal attenuation caused by the laminated glass is less than or equal to 8 dB. Even further optionally, in the frequency range from 30 MHz to 3000 MHz, the absolute difference between the maximum signal attenuation and the minimum signal attenuation caused by the laminated glass is less than or equal to 5 dB.

Additionally, the deposited metal coatings are prone to showing color deviation due to process adjustments. The laminated glass deposited with metal coatings in the existing technology usually appears blue or blue-green tint, and thus the color deviation can be observed. Compared to the deposited metal coatings, the non-metal reflective film is less sensitive to the process adjustments, preventing color deviation and contributing to the vehicle's overall appearance and aesthetic appeal.

Moreover, the process for depositing metal coatings is relatively complex, requiring specialized equipment and materials, which increases production costs. Compared with the deposited metal coatings, the non-metal reflective film does not contain metallic elements such as Ag, Au, Cu, Al, Fe, Ni, Cr, Co, Mn, etc., resulting in lower production costs and contributing to reduction in the overall cost of the vehicle.

In summary, the non-metal reflective film incorporated in the laminated glass can function to reflect infrared light, addressing the thermal insulation issues in vehicle thermal management. Meanwhile, compared with metal coatings, the laminated glass incorporating the non-metal reflective film has a dielectric constant close to that of the surrounding air, which avoids interference with the electromagnetic environment around antennas, shielding substantially no electromagnetic wave signals emitted by the antennas, thereby ensuring high signal transmittance and improving the quality of wireless communication inside the vehicle. Additionally, unlike the deposited metal coatings, which are prone to showing color deviation due to process adjustments, the non-metal reflective film is less sensitive to the process adjustments, preventing color deviation and contributing to the vehicle's overall appearance and aesthetic appeal. Moreover, the costs of depositing the non-metal reflective film are lower than those of depositing metal coatings, helping to reduce product costs.

Optionally, a thickness of the non-metal reflective film is in a range from 40 μm to 200 μm. For example, the thickness of the non-metal reflective film is 40 μm, 50 μm, 80 μm, 100 μm, 120 μm, 150 μm, 180 μm, or 200 μm. Further optionally, the thickness of the non-metal reflective film is in a range from 50 μm to 100 μm.

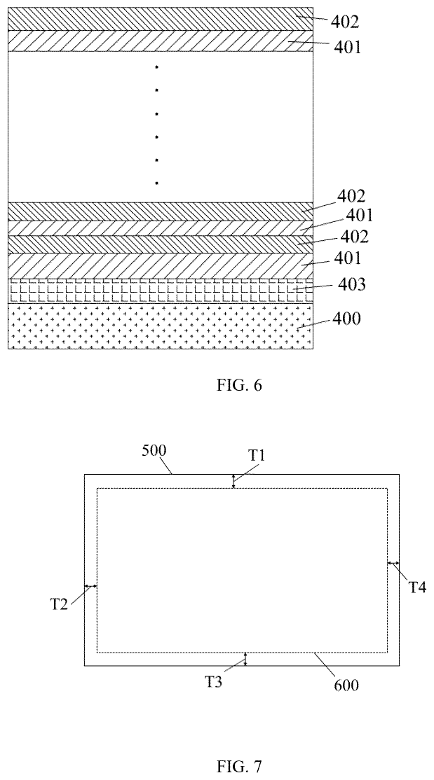

Referring to FIGS. 5 and 6, the non-metal reflective film includes high refractive index layers 401 and low refractive index layers 402 alternately stacked with each other. The refractive index of the high refractive index layer 401 is denoted as n1, and the refractive index of the low refractive index layer 402 is denoted as n2, where n1 and n2 satisfy: n1−n2≥0.05. Further optionally, n1 and n2 satisfy: n1−n2≥0.2. Further optionally, n1 and n2 satisfy: n1−n2≥0.5. Further optionally, n1 and n2 satisfy: n1−n2≥0.8.

Optionally, the non-metal reflective film further includes a polymer film 400. The high refractive index layers 401 and low refractive index layers 402 are alternately stacked on at least one surface of the polymer film 400. The polymer film 400 can serve to support the high refractive index layers 401 and the low refractive index layers 402. Optionally, the material of the polymer film 400 is selected from polyethylene terephthalate (PET), polyimide (PI), biaxially oriented polypropylene film (BOPP), etc.

The laminated glass can be used as a front windshield, a sunroof, or a side window. When rain falls, water droplets can adhere to the surface of the laminated glass. These droplets, irregular in shape and size, behave as tiny lenses. As light passes through these droplets, it can be further refracted and scattered, altering the light's path. Conventional laminated glass with metal coatings typically produces more complex and colorful reflections once water droplets adhere to the first surface, creating a visually iridescent effect. Moreover, the observed colors may vary with the viewer's position and angle.

To prevent the complex and colorful reflections caused by water droplets on the laminated glass, optionally, the non-metal reflective film further includes a color-adjusting layer 403. The color-adjusting layer 403 can absorb specific colors in visible light, thereby causing the reflected color on the outer surface of the laminated glass to appear as a specific color, such as neutral gray, making the reflected color more uniform and mitigating the iridescent effect caused by water droplets.

In the present application, the color-adjusting layer 403 can be formed via magnetron sputtering, sol-gel process, or co-extrusion process. In some embodiments, the material of the high refractive index layers and the material of the low refractive index layers each are an inorganic compound, and the color-adjusting layer 403 can be formed via magnetron sputtering or sol-gel process. In some other embodiments, the material of the high refractive index layers and the material of the low refractive index layers each are an organic polymer, and the color-adjusting layer 403 can be formed via magnetron sputtering, sol-gel process, or co-extrusion process.

Specifically, the color-adjusting layer 403 can absorb specific colors in visible light. For example, the color-adjusting layer 403 can absorb red light with wavelengths in a range from 620 nm to 750 nm, wherein the color-adjusting layer 403 contains a red light absorbent, such as a dye-based light absorbent or a pigment-based red light absorbent. As another example, the color-adjusting layer 403 can absorb blue light with wavelengths in a range from 420 nm to 480 nm, wherein the color-adjusting layer 403 contains a blue light absorbent, such as an azo-based blue light absorbent, an isoindolinone-based blue light absorbent, a quinophthalone-based blue light absorbent, a benzimidazolone-based blue light absorbent, or an organic-inorganic composite blue light absorbent. As another example, the color-adjusting layer 403 can absorb yellow light with wavelengths in a range from 570 nm to 590 nm, wherein the color-adjusting layer 403 contains a yellow light absorbent, such as a metal coordination compound, an azo-based dye, or a conjugated polycyclic organic compound containing heteroatoms.

In the embodiment shown in FIG. 5, the color-adjusting layer 403 is the layer of the non-metal reflective film farthest from the polymer film 400, and the color-adjusting layer 403 is in direct contact only with a low refractive index layer 402 of the non-metal reflective film.

In the embodiment shown in FIG. 6, the color-adjusting layer 403 is the layer of the non-metal reflective film closest to the polymer film 400, and the color-adjusting layer 403 is in direct contact only with a high refractive index layer 401 and the polymer film 400 of the non-metal reflective film.

In some other embodiments, the color-adjusting layer 403 can be located between adjacent high refractive index layer 401 and low refractive index layer 402.

Optionally, the color-adjusting layer 403 is the layer of the non-metal reflective film closest to the first surface.

Optionally, the layer of the non-metal reflective film closest to the first surface is a high refractive index layer.

Optionally, the layer of the non-metal reflective film closest to the first surface is a low refractive index layer.

Optionally, the thickness of the color-adjusting layer is in a range from 1 μm to 10 μm. For example, the thickness of the color-adjusting layer can be 1 μm, 2 μm, 3 μm, 4 μm, 5 μm, 6 μm, 7 μm, 8 μm, 9 μm, or 10 μm.

Optionally, the visible light transmittance TL1 of the non-metal reflective film excluding the color-adjusting layer satisfies: TL1≥85%. Further optionally, TL1 satisfies: TL1≥90%.

Optionally, the visible light transmittance TL2 of the non-metal reflective film including the color-adjusting layer satisfies: 75%<TL2≤80%. Such a non-metal reflective film can be applied to laminated glass requiring a relatively high visible light transmittance.

Optionally, the visible light transmittance TL2 of the non-metal reflective film including the color-adjusting layer satisfies: TL2≤60%. Further optionally, TL2 satisfies: TL2≤55%. Such a non-metal reflective film can be applied to laminated glass requiring a relatively low visible light transmittance.

In some embodiments, the laminated glass has a relatively high visible light transmittance and can be used as a front windshield, a front door glass, a rear windshield, etc., meeting high transmittance requirements to ensure driving safety. Optionally, the visible light transmittance of the laminated glass is greater than or equal to 70%. Optionally, the visible light transmittance of the laminated glass is in a range from 70% to 95%, such as 70%, 75%, 80%, 85%, 90%, 95%, etc.

In some other embodiments, the laminated glass has a relatively low visible light transmittance and can be used as a vehicle sunroof, a rear door glass, a quarter glass, etc., to prevent rear passengers from being exposed to glaring sunlight. Optionally, the visible light transmittance of the laminated glass is less than or equal to 30%. Optionally, the visible light transmittance of the laminated glass is in a range from 0.5% to 30%, such as 0.5%, 1%, 2%, 3%, 4%, 5%, 8%, 10%, 15%, 20%, 25%, 30%, etc. Further optionally, the visible light transmittance of the laminated glass is less than or equal to 10%. Optionally, the visible light transmittance of the laminated glass is in a range from 0.5% to 10%, providing better thermal insulation and privacy protection.

Optionally, the reflectance RL of the laminated glass for visible light incident from a first surface side satisfies: RL≤20%, RL≤18%, RL≤15%, RL≤12%, or RL≤11%, to avoid light pollution to the external environment of the vehicle.

Optionally, the total solar energy transmittance TTS of the laminated glass satisfies: TTS≤60%, TTS≤55%, TTS≤50%, TTS≤45%, TTS≤40%, or TTS≤30%, to provide relatively good thermal insulation effects.

In some embodiments, a shrinkage rate of the non-metal reflective film in a machine direction MD is in a range from 2% to 4.5% and a shrinkage rate of the non-metal reflective film in a transverse direction TD is in a range from 1.1% to 4%, which contributes to preventing curling during laminated glass production and avoiding wrinkling after production. The machine direction MD represents a flow direction, while the transverse direction TD represents the direction orthogonal to the machine direction MD. The shrinkage rate is calculated according to shrinkage rate=(D2−D1)/D1×100%, where D1 is the original dimension of the non-metal reflective film at 25° C., which is used as a baseline, and D2 is the dimension of the non-metal reflective film which is heated at 150° C. for 15 minutes and then cooled back to 25° C. The shrinkage rate in the machine direction MD is calculated based on the dimensions measured along the machine direction MD, while the shrinkage rate in the transverse direction TD is calculated based on the dimensions measured along the transverse direction TD. Optionally, the non-metal reflective film exhibits a shrinkage rate in a range from 2.5% to 4% in the machine direction MD and a shrinkage rate in a range from 1.5% to 3.5% in the transverse direction TD.

Referring to FIG. 7, the laminated glass has a contour boundary 500, and the non-metal reflective film has a contour boundary 600. The contour boundary 500 of the laminated glass and the contour boundary 600 of the non-metal reflective film are parallel to each other. The non-metal reflective film is smaller than the laminated glass, i.e., the contour boundary 600 of the non-metal reflective film is located at an inner side of the contour boundary 500 of the laminated glass. The distances between the contour boundary 600 of the non-metal reflective film and the contour boundary 500 of the laminated glass are T1, T2, T3, and T4. The minimum value among T1, T2, T3, and T4 represents the minimum distance between the contour boundary 600 of the non-metal reflective film and the contour boundary 500 of the laminated glass. The minimum distance is in a range from 5 mm to 20 mm, and specifically, can be 5 mm, 6 mm, 8 mm, 10 mm, 12 mm, 15 mm, 18 mm, 20 mm, etc. This configuration allows the non-metal reflective film to be more stably embedded in the laminated glass and facilitates edge trimming during production of the laminated glass.

In some embodiments, the color of light reflected from an outer surface of the laminated glass measured from the first surface side has following values in a Lab color space: value a is in a range from −2 to 0 and value b is in a range from −2 to 0.5, which facilitates obtaining laminated glass with neutral color and an aesthetic appearance. Optionally, value a is in a range from −1 to 0 and value b is in a range from −1 to 0.5. Further optionally, value a is in a range from −0.5 to 0 and value b is in a range from −0.5 to 0.5.

In the present application, the non-metal reflective film includes high refractive index layers and low refractive index layers alternately stacked with each other, where the material of each of the high refractive index layers and the material of the low refractive index layers is a non-metallic material.

In some embodiments, the material of each of the high refractive index layers and the material of the low refractive index layers is an inorganic compound, and the total number of the high refractive index layers and low refractive index layers is in a range from 4 to 20. Optionally, n1 and n2 satisfy: n1−n2≥0.2. Further optionally, n1 and n2 satisfy: n1−n2≥0.5. Further optionally, n1 and n2 satisfy: n1−n2≥0.8. Further optionally, n1 and n2 satisfy: n1−n2≥1.0.

Optionally, the material of the high refractive index layers is an oxide, nitride, or oxynitride. n1 satisfies: n1≥2.0. Further optionally, n1 satisfies: n1≥2.1. Further optionally, n1 satisfies: n1 satisfies: n1≥2.2. Further optionally, n1 satisfies: n1≥2.3. Further optionally, n1 satisfies: n1≥2.4.

Optionally, the material of the high refractive index layers is an oxide, a nitride, or an oxynitride of at least one element selected from Zn, Ti, Si, Al, Sn, Se, Zr, Ni, In, Cr, W, Ca, Y, Nb, Cu, or Sm. For example, the material of the high refractive index layers is at least one selected from TiO₂, Nb₂O₅, Ta₂O₅, ZrO₂, Si₃N₄, ZrN, or TiN.

Optionally, the material of the low refractive index layers is an oxide or a fluoride. n2 satisfies: n2≤1.8. Further optionally, n2 satisfies: n2≤1.7. Further optionally, n2 satisfies: n2≤1.6. Further optionally, n2 satisfies: n2≤1.5.

Optionally, the material of the low refractive index layers is an oxide or a fluoride of at least one element selected from Si, Al, or Mg. For example, the material of the low refractive index layers is selected from at least one of SiO₂ or Al₂O₃.

The aforementioned high refractive index layers and low refractive index layers can be formed by magnetron sputtering. When the non-metal reflective film includes the polymer film, the high refractive index layers and the low refractive index layers can be alternately deposited on the polymer film by magnetron sputtering.

In some other embodiments, the material of each of the high refractive index layers and the material of the low refractive index layers is an organic polymer, and the total number of the high refractive index layers and the low refractive index layers is in a range from 50 to 5000.

Optionally, n1 and n2 satisfy: 0.5≤n1−n2≤1.0. Further optionally, n1 and n2 satisfy: 0.8≤n1−n2≤1.0.

Optionally, the organic polymer is at least one selected from polyethylene, polypropylene, polylactic acid, poly(4-methyl-1-pentene), polyvinylidene difluoride, cyclic polyolefin, polymethyl methacrylate, polyvinyl chloride, polyvinyl alcohol, polyamide, polystyrene, polycarbonate, polyethylene terephthalate, polyethylene naphthalate, polyphenylene sulfide, and polyetherimide.

The high refractive index layers and the low refractive index layers can be formed through a co-extrusion process. When the non-metal reflective film includes the polymer film, the polymer film can also be formed simultaneously through the above co-extrusion process.

The outer glass sheet includes the first surface and the second surface disposed opposite to each other. The outer glass sheet is transparent glass or tinted glass, with a thickness in a range from 0.7 mm to 4.0 mm, such as 0.7 mm, 1 mm, 1.6 mm, 2.1 mm, 3.2 mm, 4 mm, etc. Optionally, the thickness of the outer glass sheet is in a range from 1.6 mm to 3.5 mm.

The inner glass sheet includes the third surface and the fourth surface disposed opposite to each other. The inner glass sheet is transparent glass or tinted glass, with a thickness in a range from 0.7 mm to 4.0 mm, such as 0.7 mm, 1 mm, 1.6 mm, 2.1 mm, 3.2 mm, 4 mm, etc. Optionally, the thickness of the outer glass sheet is in a range from 0.7 mm to 2.1 mm.

The adhesive layer 13 is disposed between the second surface 11B and the third surface 12A, bonding the outer glass sheet 11 to the inner glass sheet 12. It can be understood that the second surface of the outer glass sheet and the third surface of the inner glass sheet are connected via the adhesive layer. The material of the adhesive layer is not limited in the present application. Optionally, the material of the adhesive layer can include polyvinyl butyral (PVB), an ethylene-vinyl acetate copolymer (EVA), or an ionic polymer film (SGP). When the adhesive layer includes a first adhesive layer and a second adhesive layer, the first adhesive layer and the second adhesive layer are each independently selected from at least one of polyvinyl butyral (PVB), an ethylene-vinyl acetate copolymer (EVA), and an ionic polymer film (SGP). The thickness of the adhesive layer is in a range from 0.38 mm to 2.28 mm. For example, the thickness of the adhesive layer can be, but is not limited to, 0.38 mm, 0.76 mm, 1.14 mm, 1.52 mm, 1.9 mm, 2.28 mm, or other values between 0.38 mm and 2.28 mm.

A second aspect of the present application provides a vehicle, which includes the laminated glass as described above. The vehicle possesses all the advantages of the laminated glass, which will not be repeated herein.

The present application will be further described with reference to specific examples and comparative examples. The structures of the laminated glass in the following specific examples and comparative examples are as follows:

### Comparative Example 1 and Examples 1 and 2

Comparative Example 1: A transparent glass (i.e., an outer glass sheet) with a thickness of 2.1 mm+transparent PVB (i.e., an adhesive layer) with a thickness of 0.76 mm+a green glass (i.e., an inner glass sheet) with a thickness of 2.1 mm.

Example 1: A transparent glass (i.e., an outer glass sheet) with a thickness of 2.1 mm+transparent PVB (i.e., a first adhesive layer) with a thickness of 0.38 mm+a non-metal reflective film (without a color-adjusting layer) with a thickness of 0.05 mm+transparent PVB (i.e., a second adhesive layer) with a thickness of 0.38 mm+a green glass (i.e., an inner glass sheet) with a thickness of 2.1 mm.

Example 2: A transparent glass (i.e., an outer glass sheet) with a thickness of 2.1 mm+transparent PVB (i.e., a first adhesive layer) with a thickness of 0.38 mm+a non-metal reflective film (without a color-adjusting layer) with a thickness of 0.05 mm+heat-absorbing PVB (i.e., a second adhesive layer) with a thickness of 0.38 mm+a green glass (i.e., an inner glass sheet) with a thickness of 2.1 mm.

The laminated glass samples of Comparative Example 1 and Examples 1 and 2 were tested for visible light transmittance TL, visible light reflectance RL, solar direct reflectance RE, and total solar energy transmittance TTS. The measurement results are recorded in Table 1.

The visible light transmittance TL was measured and calculated according to standard ISO9050.

The visible light reflectance RL was measured from the first surface side of the laminated glass, calculated according to standard ISO9050.

The solar direct reflectance RE was measured from the first surface side of the laminated glass, calculated according to standard ISO9050.

The total solar energy transmittance TTS was measured and calculated according to standard ISO9050.

TABLE 1
Measurement results from Comparative
Example 1 and Examples 1 and 2

| | Visible | Visible | Solar | Total |
|---|---|---|---|---|
| | light | light | direct | solar energy |
| | transmittance | reflectance | reflectance | transmittance |
| | TL | RL | RE | TTS |
| Comparative | 82% | 8.5% | 6.6% | 66.9% |
| Example 1 | | | | |
| Example 1 | 79.8% | 10.7% | 22.7% | 56.3% |
| Example 2 | 78.5% | 9.7% | 21% | 51.5% |

As can be seen from Table 1, Comparative Example 1 did not include the non-metal reflective film as described in the present application. By incorporating the non-metal reflective film in Examples 1 and 2, the visible light transmittance TL of Examples 1 and 2 slightly decreased but was still above 70%. The visible light reflectance RL of Examples 1 and 2 slightly increased but was still below 15%. The solar direct reflectance RE of Examples 1 and 2 significantly increased to above 20%. The total solar energy transmittance TTS of Examples 1 and 2 substantially decreased to below 60%, even below 55%, demonstrating excellent thermal insulation performance of the laminated glass from Examples 1 and 2.

### Comparative Example 2 and Examples 3 to 7

Comparative Example 2: A transparent glass (i.e., an outer glass sheet) with a thickness of 2.1 mm+transparent PVB (i.e., an adhesive layer) with a thickness of 0.76 mm+a transparent glass (i.e., an inner glass sheet) with a thickness of 2.1 mm.

Example 3: A transparent glass (i.e., an outer glass sheet) with a thickness of 2.1 mm+transparent PVB (i.e., a first adhesive layer) with a thickness of 0.38 mm+a non-metal reflective film (TL=58%, containing a color-adjusting layer) with a thickness of 0.054 mm+gray PVB (i.e., a second adhesive layer) with a thickness of 0.76 mm+a transparent glass (i.e., an inner glass sheet) with a thickness of 2.1 mm.

Example 4: A transparent glass (i.e., an outer glass sheet) with a thickness of 2.1 mm+transparent PVB (i.e., a first adhesive layer) with a thickness of 0.38 mm+a non-metal reflective film (TL=58%, containing a color-adjusting layer) with a thickness of 0.054 mm+gray PVB (i.e., a second adhesive layer) with a thickness of 0.76 mm+a green glass (i.e., an inner glass sheet) with a thickness of 2.1 mm.

Example 5: A transparent glass (i.e., an outer glass sheet) with a thickness of 2.1 mm+transparent PVB with a thickness of 0.38 mm+a non-metal reflective film (TL=80%, containing a color-adjusting layer) with a thickness of 0.054 mm+transparent PVB (i.e., a second adhesive layer) with a thickness of 0.38 mm+a green glass (i.e., an inner glass sheet) with a thickness of 2.1 mm.

Example 6: A transparent glass (i.e., an outer glass sheet) with a thickness of 2.1 mm+transparent PVB with a thickness of 0.38 mm+a non-metal reflective film (TL=80%, containing a color-adjusting layer) with a thickness of 0.054 mm+transparent heat-absorbing PVB (i.e., a second adhesive layer) with a thickness of 0.76 mm+a transparent glass (i.e., an inner glass sheet) with a thickness of 2.1 mm.

Example 7: A transparent glass (i.e., an outer glass sheet) with a thickness of 2.1 mm+transparent PVB with a thickness of 0.38 mm+a non-metal reflective film (TL=80%, containing a color-adjusting layer) with a thickness of 0.054 mm+transparent PVB (i.e., a second adhesive layer) with a thickness of 0.38 mm+a transparent glass (i.e., an inner glass sheet) with a thickness of 2.1 mm.

The laminated glass samples of Comparative Example 2 and Examples 3 to 7 were tested for visible light transmittance TL, solar direct reflectance RE, total solar energy transmittance TTS, and Lab color space values of the color of light reflected from the outer surface. The measurement results are recorded in Table 2.

The Lab color space values of the color of light reflected from the outer surface were measured from the first surface side of the laminated glass and calculated based on CIE1976 Lab color space and D65 light source, where value a represents the red-green value of the color of the reflected visible light, and value b represents the yellow-blue value of the color of the reflected visible light.

TABLE 2
Measurement results from Comparative
Example 2 and Examples 3 to 7

| | Visible | Solar | Total solar | Lab values of |
|---|---|---|---|---|
| | light | direct | energy | color reflected |
| | transmittance | reflectance | transmittance | from the |
| | TL | RE | TTS | outer surface |
| Example 2 | 89.2% | 7.75% | 80.6% | a = −0.3, |
| | | | | b = 0.26 |
| Example 3 | 1.18% | 12.7% | 25.01% | a = −1.14, |
| | | | | b = −0.57 |
| Example 4 | 1.05% | 12.8% | 24.9% | a = −1.41, |
| | | | | b = −0.9 |
| Example 5 | 71.7% | 24.5% | 55.01% | a = −1.5, |
| | | | | b = −1.5 |
| Example 6 | 70.5% | 24.3% | 50.1% | a = −1.55, |
| | | | | b = −0.76 |
| Example 7 | 75.8% | 30.74% | 53.94% | a = −0.09, |
| | | | | b = 0.32 |

As can be seen from Table 2, Comparative Example 2 employed the transparent glass and transparent PVB, resulting in that the solar direct reflectance RE and total solar energy transmittance TTS both failed to meet the usage requirements. However, value a and value b of the color of light reflected from the outer surface were both in a range from −0.5 to 0.5, close to a neutral color.

Examples 3 to 4 employed the non-metal reflective film and gray PVB, which achieved a visible light transmittance TL≤5%, even TL≤2%, a solar direct reflectance RE≥12%, and a total solar energy transmittance TTS≤30%, providing excellent thermal insulation, preventing glare, and offering privacy protection. Additionally, the color of light reflected from the outer surface had value a in a range from −1.5 to 0, and value b in a range from −1 to 0, presenting a relatively neutral and visually appealing reflective appearance.

Examples 5 to 7 employed the non-metal reflective film and transparent PVB, which achieved a visible light transmittance TL≥70%, a solar direct reflectance RE≥20%, even RE≥24%, or even RE≥30%, and a total solar energy transmittance TTS≤55%, even TTS≤50%, demonstrating excellent thermal insulation performance. Additionally, the color of light reflected from the outer surface had value a in a range from −2 to 0, and value b in a range from −2 to 0.5, or even value a is in a range from −0.5 to 0 and value b is in a range from 0 to 0.5, presenting a relatively neutral and visually appealing reflective appearance.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the patent protection of the present application shall be defined by the appended claims.

1. A laminated glass, comprising an outer glass sheet, an inner glass sheet, an adhesive layer, and a non-metal reflective film that are stacked with each other, wherein the outer glass sheet has a first surface and a second surface, the inner glass sheet has a third surface and a fourth surface, the adhesive layer is located between the second surface and the third surface, and the non-metal reflective film is located between the second surface and the adhesive layer, or is located between the adhesive layer and the third surface, or is located on the fourth surface, or is located inside the adhesive layer;
a solar direct reflectance RE of the laminated glass measured from a first surface side satisfies RE≥12%.

2. The laminated glass according to claim 1, wherein the non-metal reflective film comprises a high refractive index layer and a low refractive index layer that are alternately stacked with each other, a refractive index of the high refractive index layer is denoted as n1, a refractive index of the low refractive index layer is denoted as n2, and n1 and n2 satisfy n1−n2≥0.05.

3. The laminated glass according to claim 2, wherein the non-metal reflective film further comprises a polymer film, and the high refractive index layer and the low refractive index layer are alternately stacked on at least one surface of the polymer film.

4. The laminated glass according to claim 2, wherein the non-metal reflective film further comprises a color-adjusting layer, the color-adjusting layer is in direct contact only with the high refractive index layer of the non-metal reflective film, or is in direct contact only with the low refractive index layer of the non-metal reflective film, or is located between adjacent high refractive index layer and low refractive index layer.

5. The laminated glass according to claim 4, wherein the color-adjusting layer contains a red light absorbent; or
the color-adjusting layer contains a blue light absorbent; or
the color-adjusting layer contains a yellow light absorbent.

6. The laminated glass according to claim 4, wherein a thickness of the color-adjusting layer is in a range from 0.1 μm to 15 μm, or from 1 μm to 10 μm.

7. The laminated glass according to claim 1, wherein a thickness of the non-metal reflective film is in a range from 40 μm to 200 μm.

8. The laminated glass according to claim 2, wherein the high refractive index layer and the low refractive index layer are a plurality of high refractive index layers and a plurality of low refractive index layers that are alternately stacked with each other; a material of the high refractive index layers and a material of the low refractive index layers each are an inorganic compound, and a total layer number of the high refractive index layers and the low refractive index layers is in a range from 4 to 20.

9. The laminated glass according to claim 8, comprising at least one of following features:
(1) the material of the high refractive index layers is an oxide, a nitride, or an oxynitride, and n1 satisfies n1≥2.0;
(2) the material of the low refractive index layer is an oxide or a fluoride, and n2 satisfies n2≤1.8;
(3) n1−n2≥0.2, n1−n2≥0.5, n1−n2≥0.8, or n1−n2≥1.0;
(4) the material of the high refractive index layer is an oxide, a nitride, or an oxynitride of at least one element selected from Zn, Ti, Si, Al, Sn, Se, Zr, Ni, In, Cr, W, Ca, Y, Nb, Cu, or Sm;
(5) the material of the low refractive index layer is an oxide or a fluoride of at least one element selected from Si, Al, or Mg.

10. The laminated glass according to claim 2, wherein the high refractive index layer and the low refractive index layer are a plurality of high refractive index layers and a plurality of low refractive index layers that are alternately stacked with each other, a material of the high refractive index layers and a material of the low refractive index layers each are an organic polymer, a total number of the high refractive index layers and the low refractive index layers is in a range from 50 to 5000, and the organic polymer is at least one selected from polyethylene, polypropylene, polylactic acid, poly(4-methyl-1-pentene), polyvinylidene difluoride, cyclic polyolefin, polymethyl methacrylate, polyvinyl chloride, polyvinyl alcohol, polyamide, polystyrene, polycarbonate, polyethylene terephthalate, polyethylene naphthalate, polyphenylene sulfide, and polyetherimide; n1−n2≤0.15, or n1−n2≤0.1.

11. The laminated glass according to claim 1, wherein the laminated glass has a reflectance of at least 75% for near-infrared light in a wavelength range from 900 nm to 1100 nm incident from the first surface side.

12. The laminated glass according to claim 1, wherein in a frequency range from 30 MHz to 3000 MHz, an absolute difference between a maximum signal attenuation and a minimum signal attenuation caused by the laminated glass is less than or equal to 10 dB.

13. The laminated glass according to claim 1, wherein a visible light transmittance of the non-metal reflective film is greater than or equal to 85%, or the visible light transmittance of the non-metal reflective film is greater than 75% but less than or equal to 80%, or the visible light transmittance of the non-metal reflective film is less than or equal to 60%.

14. The laminated glass according to claim 1, wherein a visible light transmittance of the laminated glass is greater than or equal to 70%, a total solar energy transmittance of the laminated glass is less than or equal to 60%, RE≥20%, and a visible light reflectance of the laminated glass measured from the first surface side is less than or equal to 15%.

15. The laminated glass according to claim 1, wherein a visible light transmittance of the laminated glass is less than or equal to 10%, and a total solar energy transmittance of the laminated glass is less than or equal to 30%.

16. The laminated glass according to claim 1, a visible light transmittance of the laminated glass is greater than or equal to 70%, a total solar energy transmittance of the laminated glass is less than or equal to 55%, and RE≥20%.

17. The laminated glass according to claim 1, wherein a shrinkage rate of the non-metal reflective film in a machine direction MD is in a range from 2% to 4.5%, and a shrinkage rate of the non-metal reflective film in a transverse direction TD is in a range from 1.1% to 4%.

18. The laminated glass according to claim 1, wherein a minimum distance between a contour boundary of the non-metal reflective film and a contour boundary of the laminated glass is in a range from 5 mm to 20 mm.

19. The laminated glass according to claim 1, wherein a color of light reflected from an outer surface of the laminated glass measured from the first surface side has following values in a Lab color space:
value a is in a range from −2 to 0, and value b is in a range from −2 to 0.5; or
value a is in a range from −1 to 0, and value b is in a range from −1 to 0.5; or
value a is in a range from −0.5 to 0, and value b is in a range from −0.5 to 0.5.

20. A vehicle, comprising the laminated glass according to claim 1.
